(19) United States
(12) Patent Application Publication
(10) Pub. No.: US 2013/0308835 A1
(43) Pub. Date: Nov. 21, 2013

(54) Mobile Communication Device with Image Recognition and Method of Operation Therefor

(71) Applicant: Dean E. Thorson, Grayslake, IL (US)

(72) Inventor: Dean E. Thorson, Grayslake, IL (US)

(73) Assignee: Motorola Mobility, Inc., Libertyville, IL (US)

(21) Appl. No.: 13/476,636

(22) Filed: May 21, 2012

(51) Int. Cl. G06K 9/62

(52) U.S. Cl. 382/118

(57) ABSTRACT

A disclosed mobile communication device includes control logic, operatively coupled to a proximity detector, at least one camera, and to at least one transceiver. A method of operation includes capturing an image using the mobile communication device camera, in response to determining that the mobile communication device is within a threshold proximity of the user's head, performing image recognition on the image to recognize at least one human feature of the user, correlating the recognized at least one human feature to a user attribute, and providing image based control based on the user attribute. The method may include correlating by performing a lookup operation of the recognized at least one human feature using a lookup table to identify the user attribute. The human features may be an approximate ear size and a user attribute may be a user's approximate age.

### FIELD OF THE DISCLOSURE

The present disclosure relates generally to mobile communication devices and more particularly to mobile communication devices having integrated cameras.

### BACKGROUND

Mobile communication devices such as mobile communication devices often include one or more cameras such as “front facing” cameras that may be used to engage in video phone calls. Mobile communication devices may also have “rear facing” cameras that are used to take photographs, where the mobile communication device display is used as a camera viewer to position the rear facing camera lens with respect to the subject, in order to snap the photograph.

Image recognition capabilities are rapidly advancing, and facial recognition techniques exist that can detect and recognize various features of a human face in an image. The cameras present in mobile devices may be integrated with various facial recognition capabilities.

### BRIEF DESCRIPTION OF THE DRAWINGS

FIG. 1 is a block diagram of a mobile communication device having a front facing camera and control logic in accordance with an embodiment. The control logic includes image recognition logic to detect and recognize human features of a user.

FIG. 2 is block diagram showing a mobile communication device with image recognition logic to detect and recognize a human ear and a corresponding ear length and ear width, in accordance with an embodiment.

FIG. 3 is block diagram of a mobile communication device having control logic in accordance with an embodiment.

FIG. 4 is a flow chart showing operation of a mobile communication device in accordance with various embodiments.

FIG. 5 is a flow chart showing operation of a mobile communication device operating in accordance with the method of FIG. 4, and also using a lookup table in accordance with an embodiment.

FIG. 6 is a flow chart showing operation of a mobile communication device operating in accordance with the method of FIG. 4, where the detected and recognized human feature is approximate ear size and a user attribute is approximate age, in accordance with an embodiment.

FIG. 7 is a flow chart showing operation of a mobile communication device that provides image based control based on approximate age of the user as a user attribute, in accordance with an embodiment.

### DETAILED DESCRIPTION

The disclosed embodiments provide a mobile communication device with control logic that correlates recognized human features (such as a user's facial features) to a user attribute. The control logic provides control to applications and other aspects of the mobile communication device based on the user attribute for the specific user. In one example, the control logic may recognize the human feature of a user's ear and the size of the user's ear. The control logic is operative to correlate the ear size to an approximate age of the user as the user attribute. The control logic may then provide control of various aspects of the mobile communication device based on the user's age. For example, the control logic may control various application settings, access, content, etc. The user may, in some embodiments, provide settings according to user attributes. For example, the user may set security and/or access settings as user attributes. The control logic may then correlate recognized human features, such as facial features, of the mobile communication device owner with the security and/or access settings.

One aspect of the disclosure provides a method that includes capturing an image using a mobile communication device camera, in response to determining that the mobile communication device is within a threshold proximity of the user's head. The method continues with performing image recognition on the image to recognize at least one human feature of the user, correlating the recognized at least one human feature to a user attribute, and providing image based control based on the user attribute.

In one embodiment, the method may correlate the recognized at least one human feature to a user attribute by performing a lookup operation of the recognized at least one human feature using a lookup table to identify the user attribute. One example of the method includes performing image recognition on the image to recognize at least one human feature of the user by performing image recognition on the image to recognize the user's ear within the image and to determine an approximate ear size. That is, the at least one human feature of the user is the approximate ear size.

Another example of the method includes correlating a recognized at least one human feature to a user attribute by performing a lookup operation of the approximate ear size using a lookup table to correlate the approximate ear size to an approximate age. That is, the user attribute is the user's approximate age. In some embodiments, correlating a recognized at least one human feature to a user attribute may include performing a calculation using the approximate ear size to determine an approximate age, where the user attribute is the user's approximate age. Determining an approximate ear size may involve determining an ear length and an ear width.

The method may include determining, using a proximity detector, that the mobile communication device is within the threshold proximity of the user's head, the threshold proximity being a predetermined distance from a side of the user's head. In one example, the method step of providing image based control based on the user attribute, may include providing a control signal to at least one transceiver of the mobile communication device based on the user's approximate age. In another example, providing image based control based on the user attribute may also include accessing a user profile based on the user attribute and controlling at least one of application settings, content access settings, or mobile communication device access based on the user profile.

Another aspect of the disclosure is a mobile communication device, that includes a proximity detector, at least one camera, and control logic, operatively coupled to the proximity detector, and to the at least one camera. The control logic is operative to control the at least one camera to capture an image, in response to determining that the mobile communication device is within a threshold proximity of a user's head. The control logic can perform image recognition on the image, captured by the at least one camera, to recognize at least one human feature of the user within the image, correlate the recognized at least one human feature to a user attribute, and provide image based control based on the user attribute.

The control logic may correlate the recognized at least one human feature to a user attribute by performing a lookup operation of the recognized at least one human feature using a lookup table to identify the user attribute. The control logic may perform image recognition on the image to recognize at least one human feature of the user by performing image recognition on the image to recognize the user's ear within the image and to determine an approximate ear size, where the at least one human feature of the user is the approximate ear size.

The control logic is operative to correlate a recognized at least one human feature to a user attribute by performing a lookup operation of the approximate ear size using a lookup table to correlate the approximate ear size to an approximate age, where the user attribute is the user's approximate age. The control logic may also be operative to correlate a recognized at least one human feature to a user attribute by performing a calculation using the approximate ear size to determine an approximate age, where the user attribute is the user's approximate age.

The control logic may determine, using a proximity detector, that the mobile communication device is within the threshold proximity of the user's head, the threshold proximity being a predetermined distance from a side of the user's head or from the user's face. The control logic may provide image based control based on the user attribute including accessing a user profile based on the user attribute and controlling at least one of application settings, content access settings, or mobile communication device access based on the user profile.

The mobile communication device may include memory, operatively coupled to the control logic, containing a lookup table correlating human features to user attributes, where the control logic is operative to correlate a recognized at least one human feature to a user attribute by performing a lookup operation of the recognized at least one human feature using the lookup table to identify the user attribute.

In an example embodiment the control logic includes proximity detection logic, operatively coupled to the proximity detector, image recognition logic, operatively coupled to the proximity detection logic, image correlation logic, operatively coupled to the image recognition logic, and an image based controller, operatively coupled to the image correlation logic, the image based controller being operative to provide image based control based on the user attribute.

Another aspect of the disclosure is a computer readable, non-volatile, non-transitory memory that stores executable instructions for execution by at least one processor. When executed, the instructions cause the at least one processor to perform the various methods and operations herein disclosed.

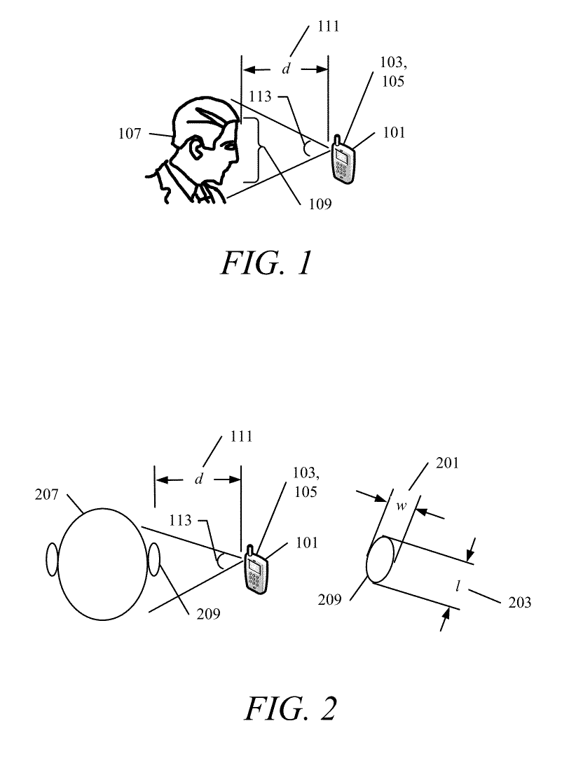

Turning now to the drawings wherein like numerals represent like components, FIG. 1 is a block diagram of a mobile communication device 101 having a front facing camera 103 and control logic in accordance with an embodiment. The control logic includes image recognition logic to detect and recognize human features 109 of a user.

The mobile communication device 101 also includes a proximity detector 105. The proximity detector 105 is operative to detect when the user's head 107 is within a threshold proximity 111. The threshold proximity 111 may define a distance “d” that provides a suitable camera angle 113 so that the user's head 107 is adequately covered by the mobile communication device camera 103 lens. In other words, the distance “d” ensures that at least one human feature of the user's human features 109 can be captured in an image by providing a wide enough camera angle 113. In accordance with one embodiment, as the user brings the mobile communication device 101 within the threshold proximity 111 of the user's head 107, the proximity detector 105 will detect that the mobile communication device 101 is within the threshold proximity 111, and will operate the camera 103 to take an image of the user's head 107, that is, capturing at least one human feature of the user's human features 109.

FIG. 2 is block diagram showing the mobile communication device 101 with image recognition logic to detect and recognize a human ear 209 and a corresponding ear length 203 and ear width 201, in accordance with an embodiment. As the mobile communication device 101 user draws the mobile communication device 101 toward the side of the user's head 207, the proximity detector 105 will detect that the mobile communication device 101 is within the threshold proximity 111, such that a suitable angle 113 is achieved. The control logic, and accordance with the embodiments, will operate the camera 103 to take an image of the side of the user's head 207. The captured image will include the user's ear 209. The control logic will detect and recognize at least one human feature, in this example the user's ear 209, and may determine the ear width 201 and ear length 203. The distance “d” is also a predetermined distance that enables the image recognition logic to determine the ear width 201 and ear length 203. Although an ear is used in the present example, other human features may have also been used, for example, an eye, nose, mouth, wrinkle pattern etc., or various combinations of such various human features.

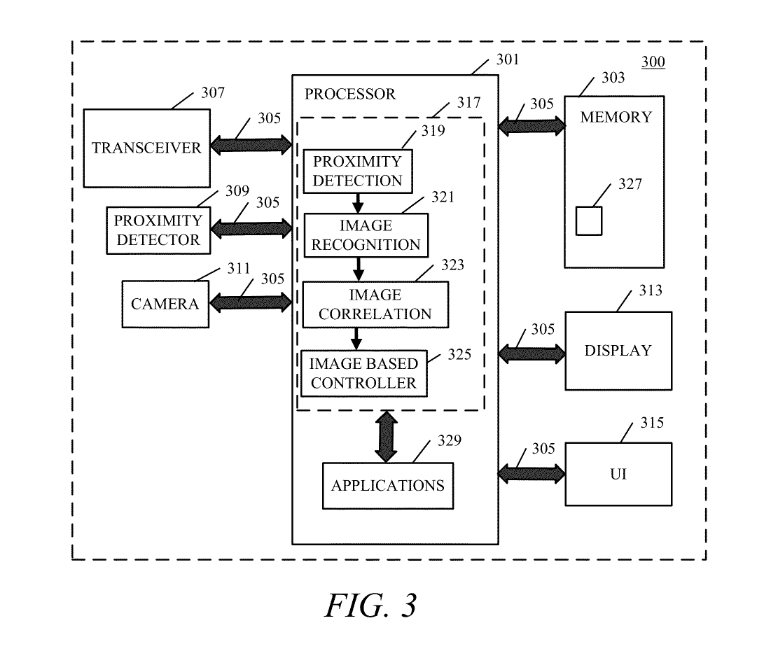

FIG. 3 is block diagram of a mobile communication device 300 having control logic 317 in accordance with an embodiment. The mobile communication device 300 includes at least one processor 301, which is operatively coupled via an internal communication bus 305, to memory 303, a display 313 and a user interface, “UI” 315. The at least one processor 301 is also operatively coupled to at least one transceiver 307, a proximity detector 309 and at least one camera 311. The control logic 317 is also operatively coupled, and able to provide control signals, to various applications 329 of the mobile communication device 300. That is, the control logic 317 may provide control signaling to applications 329 and/or may change or control various settings of the applications 329 or prevent and/or provide access to the applications 329.

The term “logic” as used herein may include software and/or firmware executing on one or more programmable processors (including CPUs and/or GPUs), and may also include ASICs, DSPs, hardwired circuitry (logic circuitry), or combinations thereof. For the example embodiment illustrated by FIG. 3, the control logic 317 may be executable instructions stored in memory 303, which is a non-volatile, non-transitory memory.

Although the communication bus 305, which may be any appropriate interface, is shown connected directly to the various components of mobile communication device 300, it is to be understood that various other hardware and components may exist and may be intervening between the various illustrated components. That is, operatively coupled components may have various other hardware and components intervening there-between. In other words, FIG. 3 is a diagram provided as an example and is not to be construed as a complete schematic diagram of a particular implementation of a mobile communication device. FIG. 3 provides an example for the purpose of describing to those of ordinary skill how to make and use the various embodiments. Therefore FIG. 3 is limited to showing only those components necessary to describe the features and advantages of the various embodiments to those of ordinary skill. It is to be understood that various other components, circuitry, and devices may be necessary in order to implement a complete functional apparatus (such as a mobile communication device) and that those various other components, circuitry, devices, etc., are understood to be present by those of ordinary skill.

The control logic 317 may include proximity detection logic 319, image recognition logic 321, image correlation logic 323 and an image based controller 325. The proximity detection logic 319 may receive an indication from the proximity detector 309 that the mobile communication device 300 is within the threshold proximity of the user's head. The proximity detection logic 319 may then control the camera 311 to capture an image of the user's head at a predetermined distance “d.” For example, the camera 311 may be controlled to capture an image of the user's facial features, or a side of the user's head so as to capture an image of the user's ear.

The proximity detection logic 319, which is operatively coupled to, and communicates with, the image recognition logic 321, may send an indication to the image recognition logic 321 to perform image recognition on the captured image. For example, the image recognition logic 321 may detect and recognize at least one human feature, such as facial features and/or the length and width of a user's ear. The image recognition logic 321 is operatively coupled to, and communicates with, the image correlation logic 323. After the image recognition logic 321 recognizes at least one human feature such as, but not limited to, the size of a human ear, the image correlation logic 323 proceeds to make a correlation between the recognized human feature or features and a user attribute. For example, the image correlation logic 323 may make a correlation between approximate human ear size and the user's approximate age. In some embodiments, the image correlation logic 323 may make the correlation by accessing a lookup table 327 stored in memory 303. The lookup table 327 may provide various entries for various human features such as, but not limited to, facial features, human ear dimensions, pre-stored facial recognition data, and various correlations to various user attributes. An example of a user attribute is, but is not limited to, a user's approximate age, a user profile corresponding to a user identity, an application setting, a security setting, etc. In some embodiments, the lookup table 327 may store human features such as pre-captured user facial features (i.e. pre-stored facial recognition data) such that the image recognition logic 321 may recognize a specific user. That is, the image recognition logic 321 may recognize the owner of the mobile communication device 300 to, among other examples, provide access. In this example, the lookup table 327 may provide access codes that are automatically entered by the image based controller 325 if the image correlation logic 323 makes an appropriate correlation of the recognized facial features of the user to the previously stored facial features in the lookup table 327. In other words the image based controller 325 may provide secure access to the mobile communication device 300 based on the user attribute being the security settings of the recognized user. That is, the user is recognized by the image recognition logic 321 and the image correlation logic 323 correlates at least one human feature of the user to at least one corresponding user attribute. These user attributes may have been set by the user previously, and stored in the lookup table 327. The image based controller 325 may then provide access, and/or other control, to various applications 329 or to various components of mobile communication device 300. In some embodiments, the control logic 317 will have a user interface, in conjunction with the display 313 and UI 315, so that a user may select and/or enter in various user attributes. The user interface may also allow the user to capture the pre-stored facial recognition data and, if necessary, to take several images at slightly differing angles, to assist the image recognition logic 321 to make future correct image recognitions. That is, the user interface may have an image recognition training feature.

In another example embodiment, the image recognition logic 325 may recognize a human ear and determine the length and width of the ear. In this example, the image correlation logic 323 may also access the lookup table 327 stored in memory 303, to make a correlation between the size of the recognized ear and a user's approximate age. The image based controller 325 may then provide settings and/or other controls to the various applications 329 and/or components such as, but not limited to, transceiver 307 or the user interface 315. For example, if the user attribute correlated to the ear size shows that the user is a child's age, the image based controller 325 may lock or block access to certain applications 329, and/or provide other control signals to components such as, but not limited to, the transceiver 307 or the user interface 315. That is, certain users may be blocked from accessing certain applications 329 or blocked from interacting with certain functions of the user interface 315.

The image capture, determined by the proximity detector 319, may be user initiated, or may be an automatic function. The automatic function may be based on a user preference setting in some embodiments. In other words, the user may determine whether the camera 311 will capture an image upon detecting the threshold proximity, or if the camera 311 will only capture an image upon a specific user command to do so.

In another example, the dimensions of the human ear based on the image correlation performed by the image correlation logic 323, may indicate that the user's approximate age is greater than a predetermined age. In this case the image based controller 325 may control the user interface 315 and display 313 to provide a larger text display to accommodate the visual issues that may occur in users over a given age.

In view of the example embodiments provided above, one of ordinary skill may envision various other uses and applications of the various embodiments. For example, based on the user attribute being a user's approximate age, image based controller 325 may allow or block access to various types of content. In one specific example, communication from certain advertisers may be enabled or blocked, so that those advertisers may target an audience appropriate for their products and/or services.

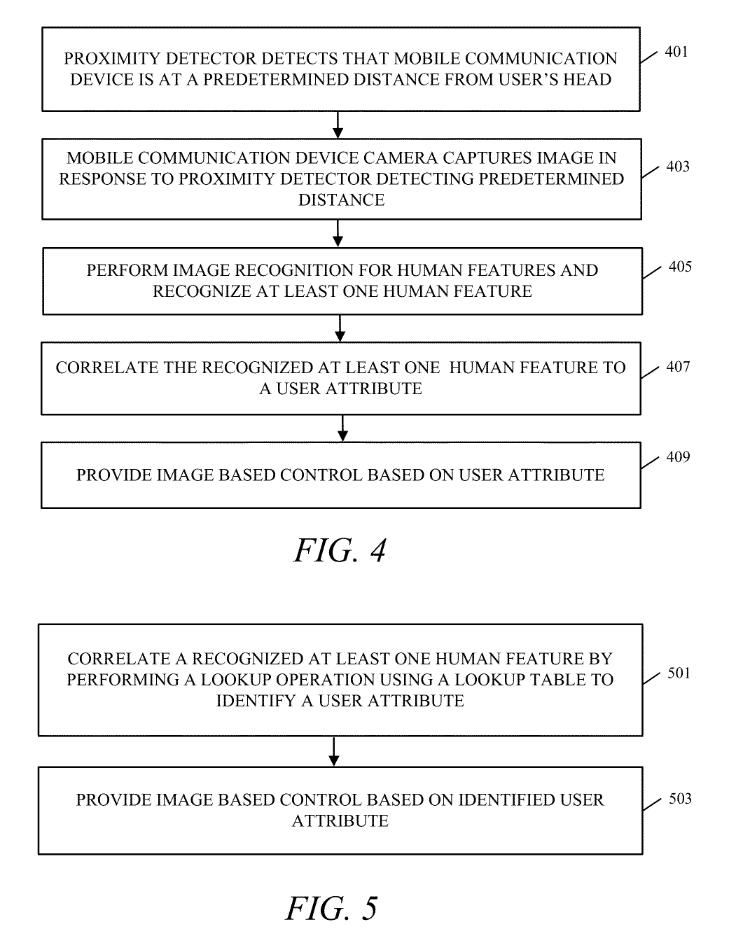

FIG. 4 is a flow chart showing operation of a mobile communication device in accordance with various embodiments. In 401, the proximity detector detects that the mobile communication device is at a predetermined distance from a user's head. For example, as was described with respect to FIG. 1 and FIG. 2, a threshold proximity 111 may be set based on a predetermined distance “d.” The predetermined distance is such that characteristic dimensions of at least one human feature of the user's human features may be determined by the image recognition logic. The distance “d” may also be determined that provides a suitable camera lens angle 113 so that the human features 109 can be appropriately captured in an image with respect to the position of the user's head 107. Therefore, in 403, the mobile communication device camera captures an image in response to the proximity detector detecting a predetermined distance. The control logic 317 will then perform image recognition for at least one human feature as shown in block 405. The control logic 317 will then correlate the recognized at least one human feature to a user attribute as shown in 407, and provide image-based control based on the user attribute as shown in 409.

FIG. 5 is a flow chart showing operation of a mobile communication device operating in accordance with the method of FIG. 4, and also using a lookup table in accordance with an embodiment. That is, as shown in 501, the control logic may correlate a recognized at least one human feature by performing a lookup operation using a lookup table 227 to identify a user attribute. The control logic will then provide image-based control based on the identified user attribute as shown in 503.

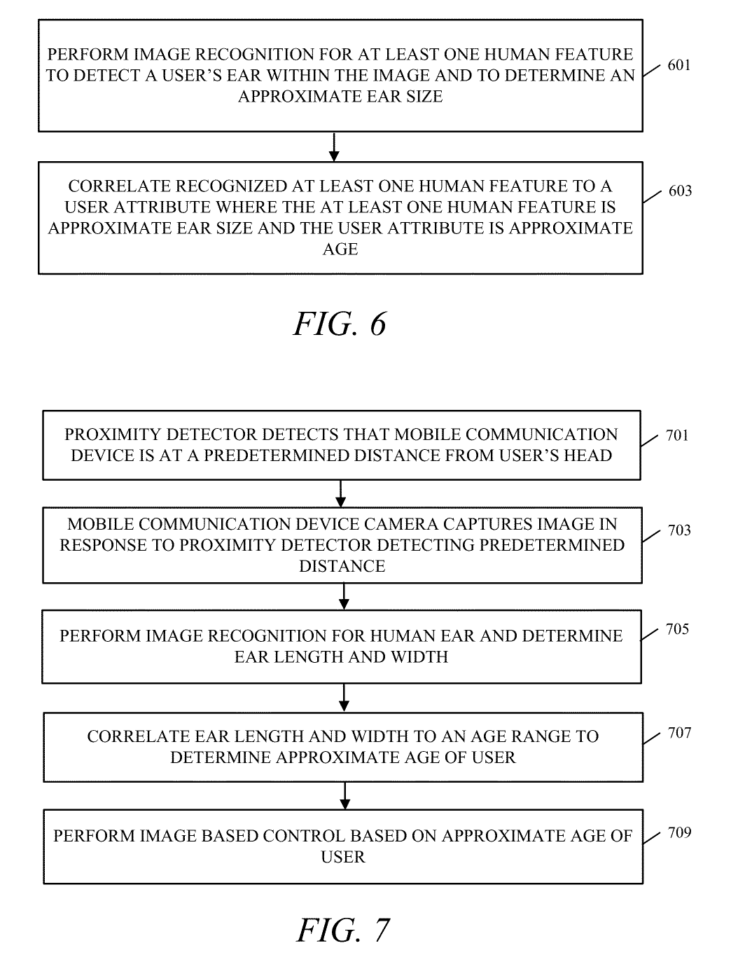

FIG. 6 is a flow chart showing operation of a mobile communication device operating in accordance with the method of FIG. 4, where the detected and recognized at least one human feature is approximate ear size and a user attribute is approximate age, in accordance with an embodiment. Therefore, in 601, the control logic performs image recognition for at least one human feature to recognize a user's ear within an image, and to determine an approximate ear size. In 603, the control logic correlates the approximate ear size to the user's approximate age.

FIG. 7 is a flow chart showing operation of a mobile communication device that provides image based control based on approximate age of a user as the user attribute, in accordance with an embodiment. In 701, the proximity detector detects that a mobile communication device is a predetermined distance from the user's head. For example as shown in FIG. 2, the mobile communication device 101 proximity detector 105, may detect that the mobile communication device 101 is within the threshold proximity 111, and capture an image at a predetermined distance “d” in order to form a suitable angle 113 for the camera 103. The predetermined distance “d” also enables determination of ear length and width. As shown in 703, the mobile communication device camera captures an image in response to the proximity detector detecting a predetermined distance. In 705, the control logic will perform image recognition and recognize a human ear and determine the length and width of the ear. As shown in 707, the control logic will correlate ear length and width to an age range to determine an approximate age of the user. In 709, the control logic will perform image-based control based on the approximate age of the user.

The various embodiments also include computer readable memory that may contain executable instructions, for execution by at least one processor, that when executed, cause the at least one processor to operate in accordance with the control logic 317 functionality herein described. The computer readable memory may be any suitable non-volatile, non-transitory, memory such as, but not limited to, programmable chips such as EEPROMS, flash ROM (thumb drives), compact discs (CDs) digital video disks (DVDs), etc., that may be used to load executable instructions or program code to other processing devices or electronic devices such as those that may benefit from the features of the herein described embodiments. The executable instructions may also include the proximity detection logic 319, image recognition logic 321, image correlation logic 323 and/or image based controller 325. The computer readable memory may also store one or more lookup tables such as example lookup table 327.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method comprising:
capturing an image using a mobile communication device camera, in response to determining that the mobile communication device is within a threshold proximity of the user's head;
performing image recognition on the image to recognize at least one human feature of the user;
correlating the recognized at least one human feature to a user attribute; and
providing image based control based on the user attribute.

2. The method of claim 1, where correlating the recognized at least one human feature to a user attribute comprises:
performing a lookup operation of the recognized at least one human feature using a lookup table to identify the user attribute.

3. The method of claim 1, where performing image recognition on the image to recognize at least one human feature of the user, comprises:
performing image recognition on the image to recognize the user's ear within the image and to determine an approximate ear size, where the at least one human feature of the user is the approximate ear size.

4. The method of claim 3, where correlating the recognized at least one human feature to a user attribute comprises:
performing a lookup operation of the approximate ear size using a lookup table to correlate the approximate ear size to an approximate age, where the user attribute is the user's approximate age.

5. The method of claim 3, where correlating the recognized at least one human feature to a user attribute comprises:
performing a calculation using the approximate ear size to determine an approximate age, where the user attribute is the user's approximate age.

6. The method of claim 3, where performing image recognition on the image to recognize the user's ear within the image and to determine an approximate ear size, comprises:
determining an ear length and an ear width.

7. The method of claim 1, comprising:
determining, using a proximity detector, that the mobile communication device is within the threshold proximity of the user's head, the threshold proximity being a predetermined distance from a side of the user's head.

8. The method of claim 4, where providing image based control based on the user attribute comprises:
providing a control signal to at least one transceiver of the mobile communication device based on the user's approximate age.

9. The method of claim 5, where providing image based control based on the user attribute comprises:
providing a control signal to at least one transceiver of the mobile communication device based on the user's approximate age.

10. The method of claim 2, where providing image based control based on the user attribute comprises:
accessing a user profile based on the user attribute and controlling at least one of application settings, content access settings, or mobile communication device access based on the user profile.

11. A mobile communication device, comprising:
a proximity detector;
at least one camera; and
control logic, operatively coupled to the proximity detector, and to the at least one camera, the control logic operative to:
control the at least one camera to capture an image, in response to determining that the mobile communication device is within a threshold proximity of a user's head;
perform image recognition on the image, captured by the at least one camera, to recognize at least one human feature of the user within the image;
correlate the recognized at least one human feature to a user attribute; and
provide image based control based on the user attribute.

12. The mobile communication device of claim 11, the control logic being operative to correlate the recognized at least one human feature to a user attribute by performing a lookup operation of the recognized at least one human feature using a lookup table to identify the user attribute.

13. The mobile communication device of claim 11, the control logic being operative to perform image recognition on the image to recognize at least one human feature of the user by performing image recognition on the image to recognize the user's ear within the image and to determine an approximate ear size, where the at least one human feature of the user is the approximate ear size.

14. The mobile communication device of claim 13, the control logic being operative to correlate the recognized at least one human feature to a user attribute by performing a lookup operation of the approximate ear size using a lookup table to correlate the approximate ear size to an approximate age, where the user attribute is the user's approximate age.

15. The mobile communication device of claim 13, the control logic being operative to correlate the recognized at least one human feature to a user attribute by performing a calculation using the approximate ear size to determine an approximate age, where the user attribute is the user's approximate age.

16. The mobile communication device of claim 13, the control logic being further operative to perform image recognition on the image to recognize the user's ear within the image and to determine an approximate ear size, by determining an ear length and an ear width.

17. The mobile communication device of claim 11, the control logic being operative to
determine, using a proximity detector, that the mobile communication device is within the threshold proximity of the user's head, the threshold proximity being a predetermined distance from a side of the user's head.

18. The mobile communication device of claim 14, the control logic being further operative to provide image based control based on the user attribute including providing a control signal to at least one transceiver of the mobile communication device based on the user's approximate age.

19. The mobile communication device of claim 15, the control logic being further operative to provide image based control based on the user attribute including providing a control signal to at least one transceiver of the mobile communication device based on the user's approximate age.

20. The mobile communication device of claim 12, the control logic being operative to provide image based control based on the user attribute including accessing a user profile based on the user attribute and controlling at least one of application settings, content access settings, or mobile communication device access based on the user profile.

21. The mobile communication device of claim 11, further comprising:
memory, operatively coupled to the control logic, containing a lookup table correlating human features to user attributes, where the control logic is operative to correlate the recognized at least one human feature to a user attribute by performing a lookup operation of the recognized at least one human feature using the lookup table to identify the user attribute.

22. The mobile communication device of claim 11, where the control logic comprises:
proximity detection logic, operatively coupled to the proximity detector, the proximity detection logic operative to determine that the mobile communication device is within the threshold proximity of the user's head, using the proximity detector, the threshold proximity being a predetermined distance from the user's head;
image recognition logic, operatively coupled to the proximity detection logic, the image recognition logic operative to perform image recognition on the image, captured by the at least one camera, to recognize at least one human feature of the user within the image;
image correlation logic, operatively coupled to the image recognition logic, the image correlation logic being operative to correlate the recognized at least one human feature to a user attribute; and
an image based controller, operatively coupled to the image correlation logic, the image based controller being operative to provide image based control based on the user attribute.

23. A computer readable, non-volatile, non-transitory memory, comprising:
executable instructions for execution by at least one processor, that when executed cause the at least one processor to:
control the at least one camera to capture an image, in response to determining that the mobile communication device is within a threshold proximity of a user's head;
perform image recognition on the image, captured by the at least one camera, to recognize at least one human feature of the user within the image;
correlate the recognized at least one human feature to a user attribute; and
provide image based control based on the user attribute.
